(19) United States
(12) Patent Application Publication
(10) Pub. No.: US 2013/0283668 A1
(43) Pub. Date: Oct. 31, 2013

(54) FISHING LURE WITH SEMICONDUCTOR INTEGRATED CIRCUIT BODY

(71) Applicant: Eric Hansen, West Jordan, UT (US)

(72) Inventor: Eric Hansen, West Jordan, UT (US)

(73) Assignee: Byte Lures, LLC, Orem, UT (US)

(21) Appl. No.: 13/458,073

(22) Filed: Apr. 27, 2012

(51) Int. Cl. A01K 85/00

(52) U.S. Cl. 43/42.32

(57) ABSTRACT

A fishing lure including an elongate body in the shape of a semiconductor integrated circuit having prongs extending from the body, the prongs being arranged in two generally parallel rows on opposite surfaces of the elongate body. The fishing lure also includes a hook coupled to a distal end of the elongate body, and an eyelet assembly coupled to a proximal end of the elongate body. Various flash materials (e.g., beads, a spoon, etc.) in combination with the prongs of the semiconductor integrated circuit shaped body stimulate the fish's natural instinct to strike. In one embodiment, the body actually comprises a semiconductor integrated circuit.

### BACKGROUND OF THE INVENTION

1. The Field of the Invention

The present invention is in the field of fishing lures.

2. The Relevant Technology

For centuries fishing has been a means of sustenance as well as a recreational activity. Inventions relating to improvements in fishing have long been important to the survival of communities reliant on fishing, while fishing, particularly as a recreational activity has lead to development of an industry involving factories, stores, markets, local shops and online retail sales.

Lures have been developed that attract fish based on a variety of different factors. Color, brilliance or shininess, movement, sound, vibration, and smell, are all features that are believed to attract fish to various types of lures.

### BRIEF SUMMARY

The present invention relates to a lure having an elongate body in the shape of a semiconductor integrated circuit having prongs extending from the body. In one embodiment, the prongs are arranged in two generally parallel rows, disposed on opposite surfaces of the elongate body. The lure further comprises a hook coupled to the distal end of the elongate body and an eyelet assembly coupled to an opposing proximal end of the elongate body. In one embodiment, the eyelet assembly comprises additional flash materials, such as a spoon, beads, etc., that act as a further attractant. The elongate body shaped as a semiconductor integrated circuit creates a unique motion and pattern of enticement that stimulates a fish to strike. The prongs extending laterally from opposing sides of the elongate body have surface area that touches the water and moves within the water creating sonar sensations, vibration, visual sensations, and light patterns within the water. The combination of the eyelet assembly, the elongate body in the shape of a semiconductor integrated circuit, and the hook create a powerful lure that stimulates the natural instincts of fish to strike.

The location of the lateral prongs positioned in a spaced apart fashion along a length of the elongate body creates a wave pattern when moved within the water that attracts fish to the lure. The ability to recycle obsolete computer semiconductor integrated circuit components that have significant fish attracting ability is beneficial to the environment.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a perspective view of a fishing lure with a semiconductor shaped body of the present invention;

FIG. 2 is a front view of the fishing lure of FIG. 1;

FIG. 3 is a back view of the fishing lure of FIG. 1;

FIG. 4 is a side view of the fishing lure of FIG. 1;

FIG. 5 is an opposing side view of the fishing lure of FIG. 1;

FIG. 6 is an end view of the fishing lure of FIG. 1;

FIG. 7 is an opposing end view of the fishing lure of FIG. 1;

FIG. 8 is a view illustrating the lure of FIG. 1 coupled to a fishing line and showing a fish being stimulated to strike the lure;

FIGS. 9A-9G show a perspective view, a top view, a bottom view, a side view, an opposing side view, an end view, and an opposing end view, respectively, of an ornamental design of a fishing lure according to the present invention.

### DETAILED DESCRIPTION OF THE PREFERRED EMBODIMENTS

### I. Introduction

In one embodiment, the present invention is directed to a fishing lure comprising an elongate body in the shape of a semiconductor integrated circuit having prongs extending from the body. In one embodiment, the prongs are arranged in two parallel rows, along opposite surfaces of the elongate body. The fishing lure also includes a hook coupled to a distal end of the elongate body, and an eyelet assembly coupled to a proximal end of the elongate body. In one embodiment, the elongate body actually comprises a semiconductor integrated circuit. Such a circuit can be a recycled integrated circuit from an obsolete computer.

### II. Exemplary Fishing Lures

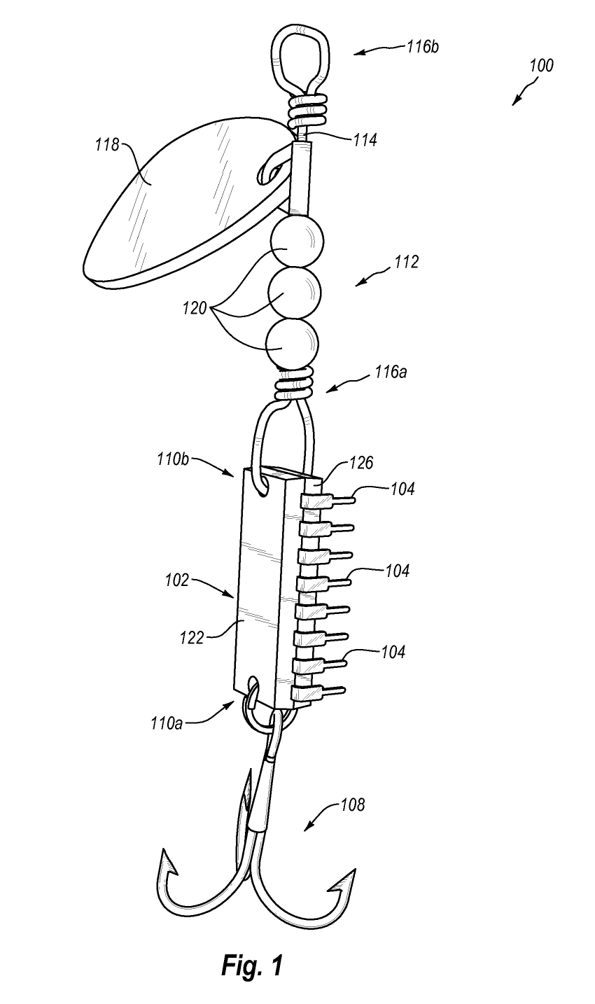

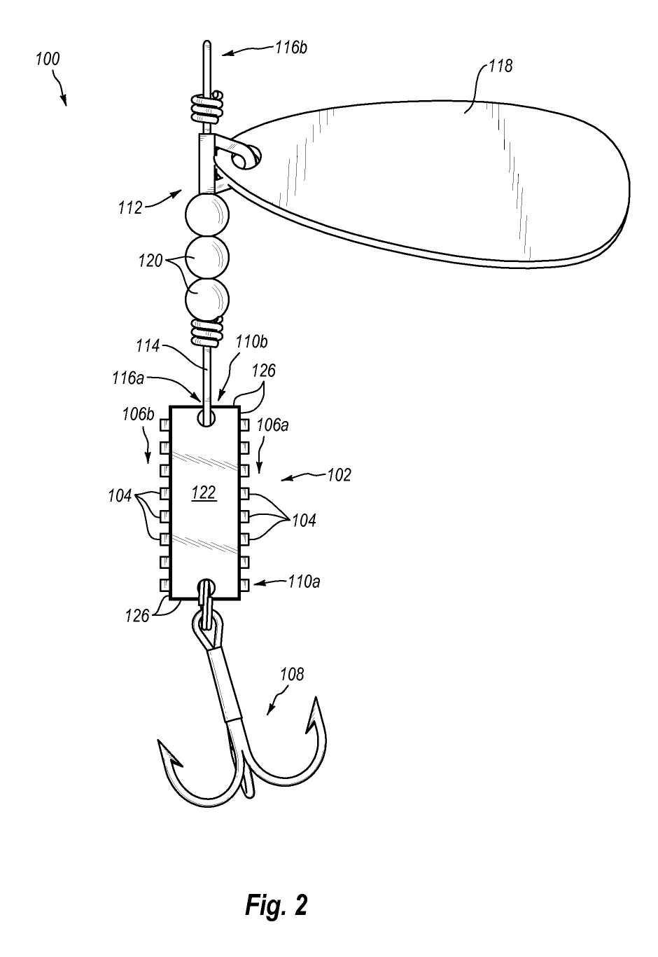

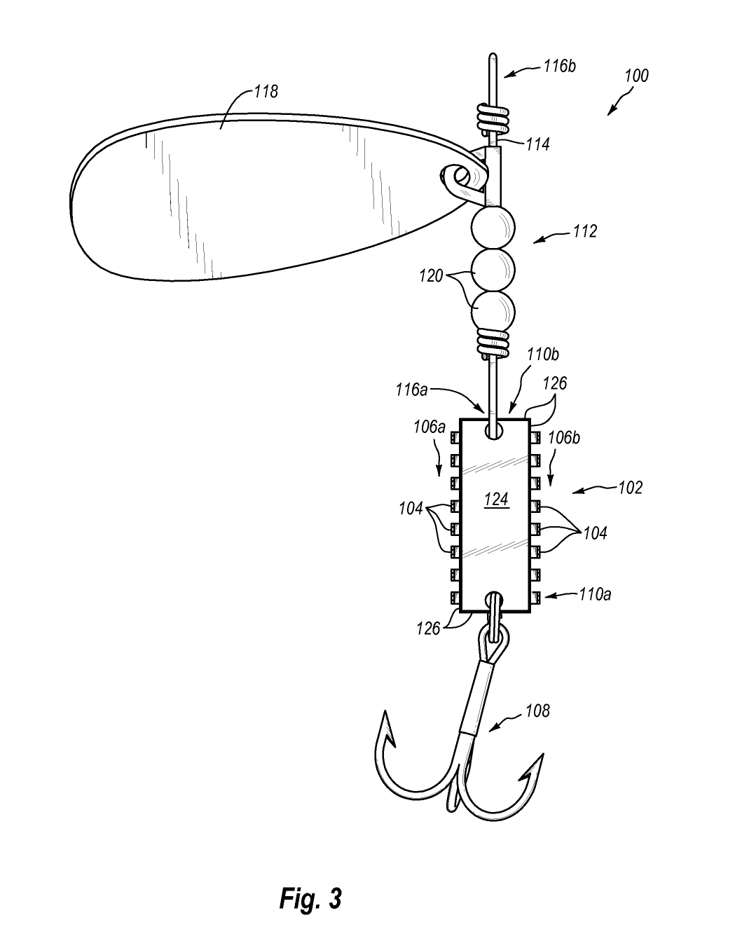

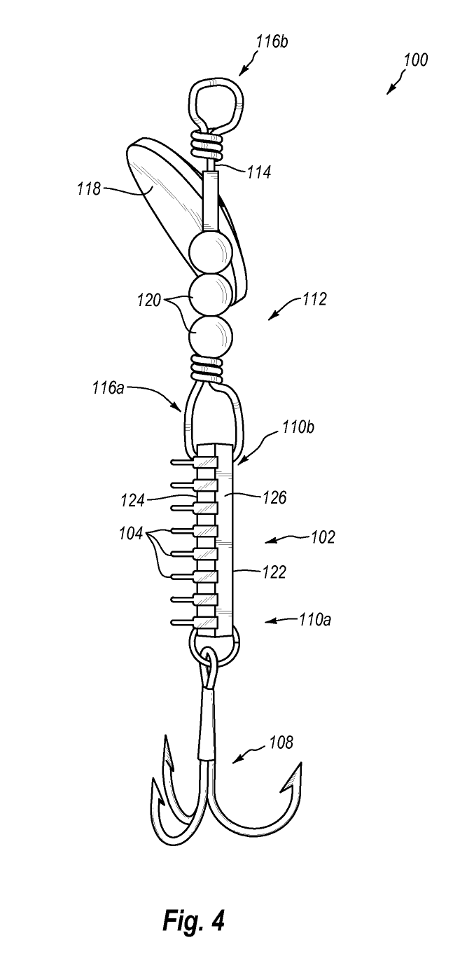

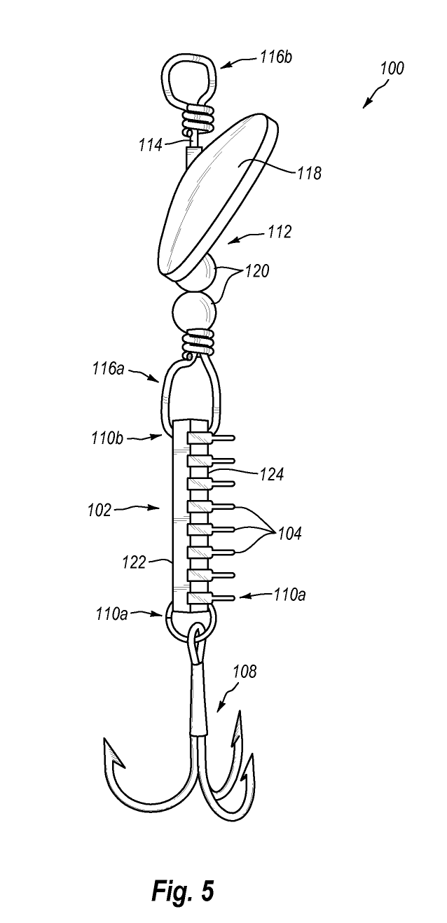

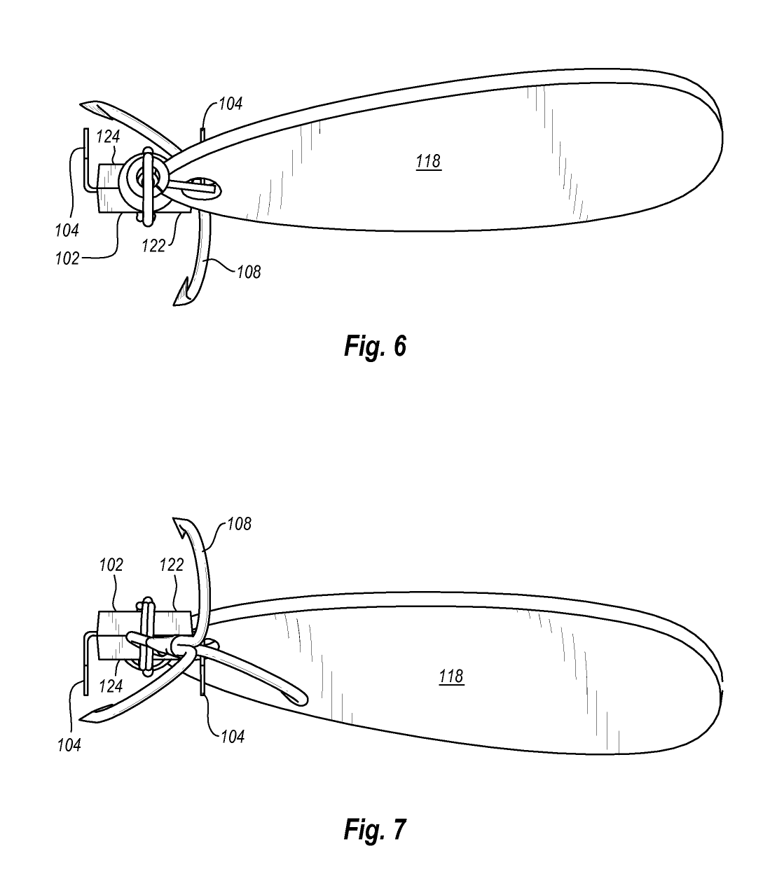

FIGS. 1-7 illustrate an exemplary fishing lure 100 according to one embodiment of the present invention. Fishing lure 100 includes an elongate body 102 in the shape of a semiconductor integrated circuit having prongs 104 arranged in two rows 106a and 106b that are generally parallel to one another. Fishing lure 100 further includes a hook 108 coupled to distal end 110a of elongate body 102, and an eyelet assembly 112 coupled to proximal end 110b of elongate body 102.

Illustrated eyelet assembly 112 comprises an elongate shaft 114 in which one end 116a (e.g., through a loop or alternative coupling mechanism) is coupled to proximal end 110b of elongate body 102. Opposing end 116b includes a loop or other coupling mechanism for coupling a fishing line to fishing lure 100. Eyelet assembly 112 is shown as further including a spoon 118, e.g., including a convex surface on one face of spoon 118 and a concave surface on an opposite face of spoon 118. Such a spoon can have a shiny, polished surface, so as to reflect light, stimulating the natural instincts of a fish to strike.

Illustrated eyelet assembly 112 is shown as further including one or more beads 120, which are threaded onto shaft 114. For example, in one embodiment beads 120 include a centrally disposed longitudinal tunnel formed therethrough to enable beads 120 to be threaded onto shaft 114. In one embodiment, beads 120 are provided with coloring (e.g., red, clear, or other colored, any of which colors may also be transparent or translucent), texturing, or other characteristics intended to stimulate the natural instincts of fish to strike.

Illustrated elongate body 102 is generally rectangular in shape. Body 102 of FIGS. 1-7 includes a front surface 122, a back surface 124, and an edge surface 126 corresponding to a thickness of body 102, disposed between front and back surfaces 122, 124. Prongs 104 extend from edge surface 126, with each row of prongs 104 disposed on edge surfaces 126 that are parallel to a longitudinal axis of elongate rectangular body 102. In another embodiment, the prongs could be disposed on the shorter edges that are perpendicular to the longitudinal axis, or some combination thereof (e.g., a semiconductor chip could include prongs extending around all 4 edge surface sides of body 102).

In the illustrated embodiment, each prong 104 includes a base portion adjacent edge surface 126 that is relatively thick, while a distal portion including the terminal end of each prong is shown to include a sharpened end, having a thickness that is reduced relative to the base portion where the prong extends from edge surface 126. As shown, in one embodiment, the sharpened ends of prongs 104 are free. The free ends of lateral prongs 104, provided in a spaced apart fashion along elongate body 102 create a wave pattern when moved within the water that attracts fish to the lure. Wave action created by prongs 104 results as the surface area of prongs 104 within the water causes water to swirl around the prongs, stimulating the natural instincts of fish to strike. For example, prongs 104 in contact with the water may create sonar sensations, vibration, visual sensations, and light patterns within the water that stimulate the natural instincts of the fish to strike. The combination of the prongs with the eyelet assembly, which may include a spoon, beads, or other features, thus creates a powerful lure that stimulates the natural instincts of fish to strike.

Hook 108 may comprise any suitable hook, including, but not limited to the treble hook 108 including 3 barbed extensions illustrated. In other embodiments, single hooks, dual hooks, and other hooks may alternatively be employed.

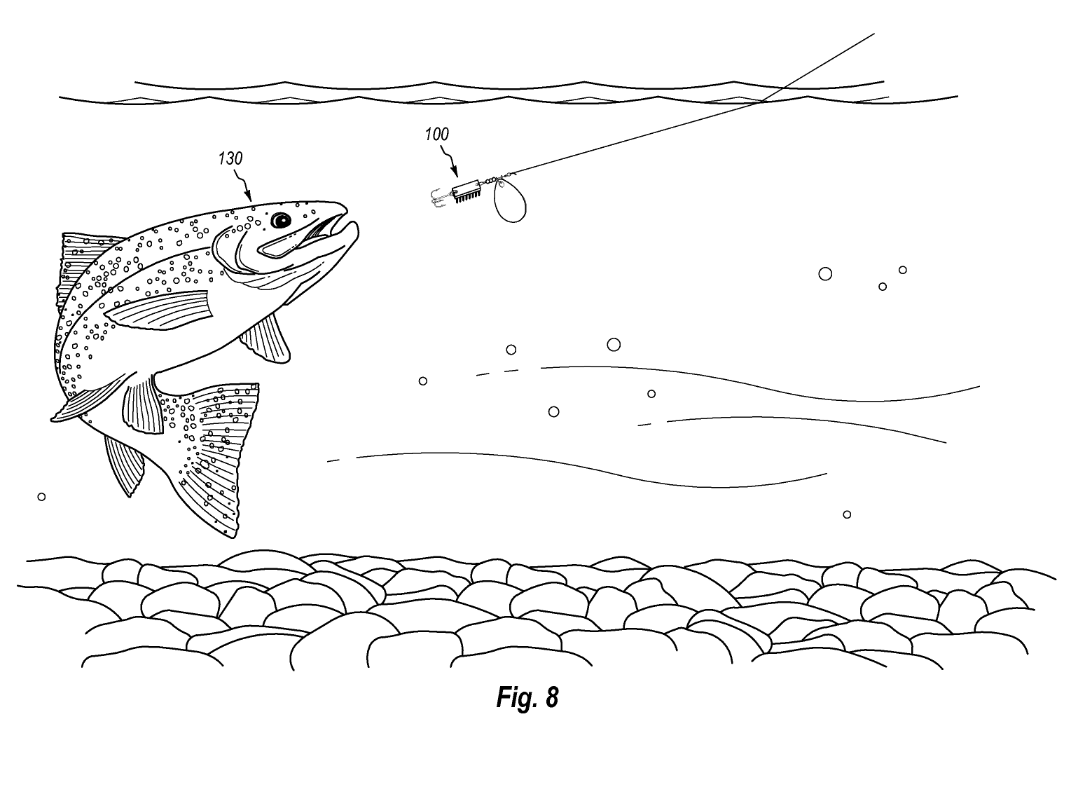

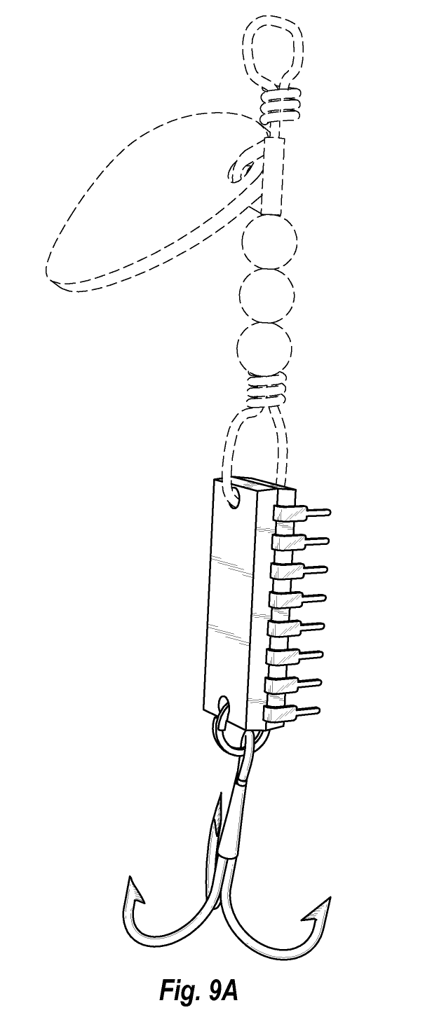

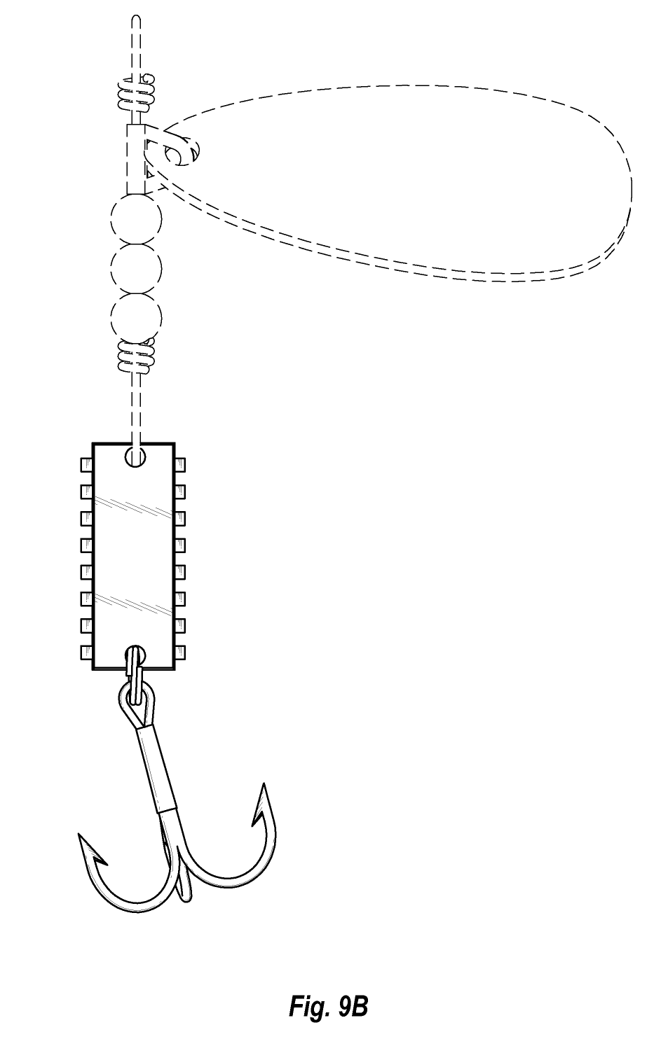

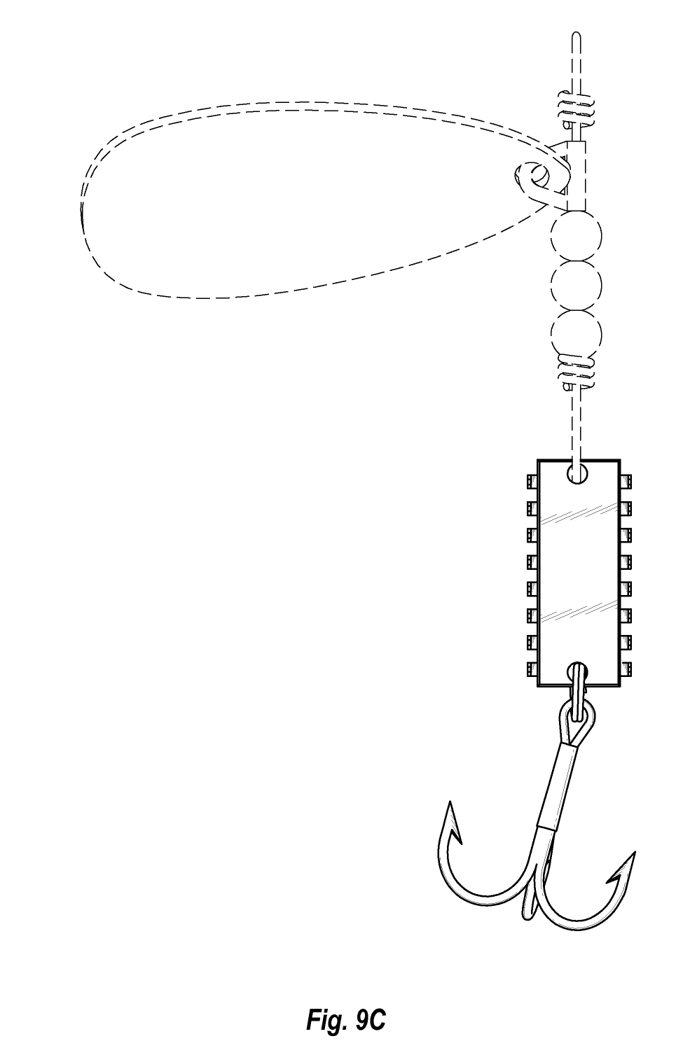

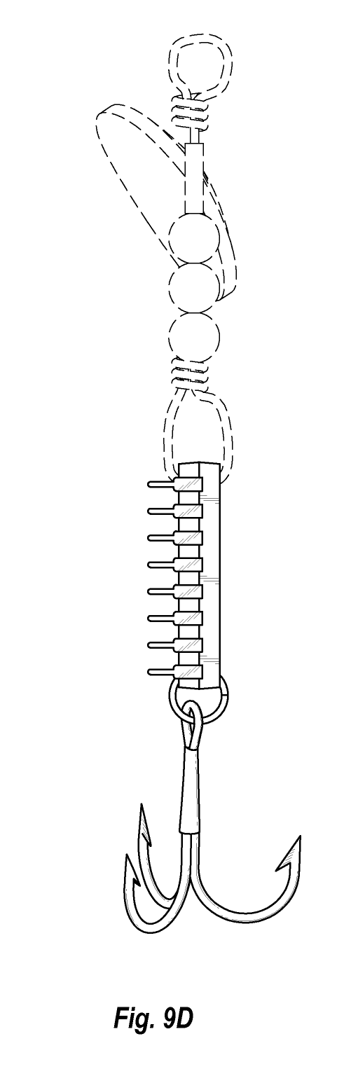

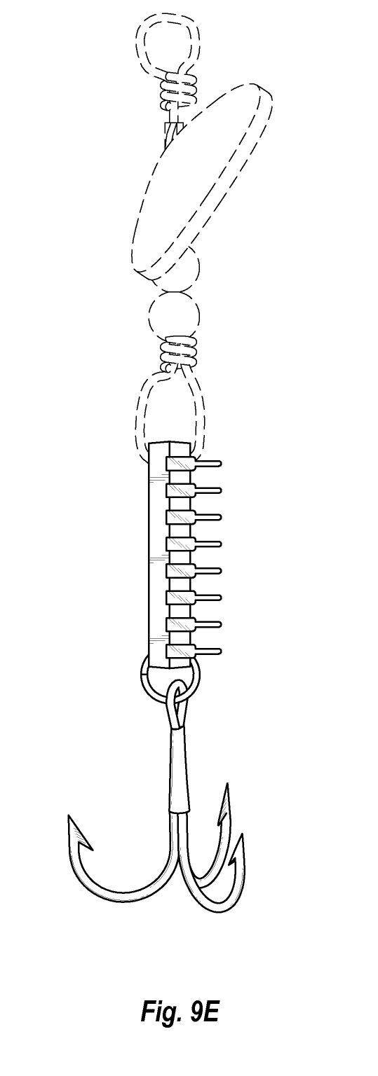

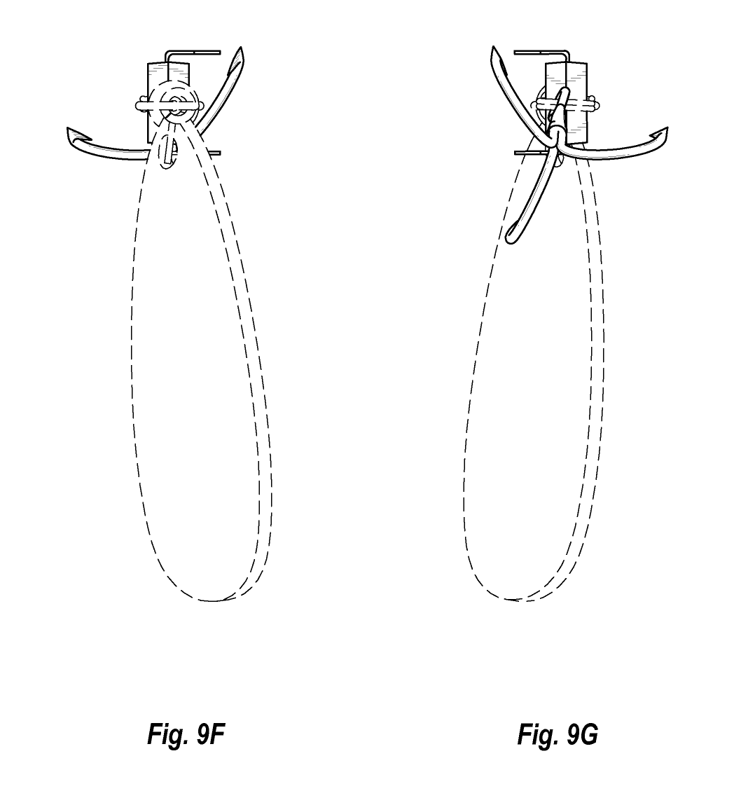

In one embodiment, the elongate body is not only be shaped so as to resemble a semiconductor integrated circuit, but actually comprises a semiconductor integrated circuit. For example, in some embodiments, elongate body 102 comprises a semiconductor integrated circuit which has been recycled from an obsolete computer (e.g., a RAM chip). The ability to recycle obsolete computer semiconductor integrated circuit components that have significant fish attracting ability is beneficial to the environment. Of course, in other embodiments, the integrated circuit is not been recycled. FIG. 8 shows a fish 130 stimulated to strike lure 100.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A fishing lure, comprising:
an elongate body in the shape of a semiconductor integrated circuit having prongs extending from the body, the prongs being arranged in two rows of prongs disposed on opposite surfaces of the elongate body, the rows being generally parallel to one another;
a hook coupled to a distal end of the elongate body; and
an eyelet assembly coupled to a proximal end of the elongate body.

2. A fishing lure as recited in claim 1 wherein the eyelet assembly comprises an elongate shaft, having one end coupled to the elongate body of the lure and an opposing end forming a loop for coupling a fishing line to the elongate shaft.

3. A fishing lure as recited in claim 2 wherein the eyelet assembly comprises a spoon coupled to the elongate shaft, the spoon including a convex surface on one surface of the spoon and a concave surface on an opposite surface of the spoon.

4. A fishing lure as recited in claim 2 wherein the eyelet assembly comprises one or more beads threaded onto the elongate shaft.

5. A fishing lure as recited in claim 1 wherein at least one of the prongs have a sharpened end at a terminal end thereof.

6. A fishing lure as recited in claim 1 wherein the prongs extend from the elongate body in a direction that is generally perpendicular to a longitudinal axis of the elongate body.

7. A fishing lure as recited in claim 1 wherein the elongate body is generally rectangular.

8. A fishing lure as recited in claim 7 wherein the rectangular elongate body includes a front surface, a back surface, and edge surfaces disposed between the front and back surfaces, wherein the rows of prongs extend from opposing edge surfaces of the rectangular elongate body.

9. A fishing lure as recited in claim 1 wherein the hook comprises a treble hook.

10. A fishing lure, comprising:
a generally rectangular elongate body comprising a semiconductor integrated circuit having a front surface, a back surface, and edge surfaces disposed therebetween, the semiconductor integrated circuit including two generally parallel rows of prongs extending from opposing edge surfaces of the semiconductor integrated circuit;
a hook coupled to a distal end of the elongate body; and
an eyelet assembly coupled to a proximal end of the elongate body.

11. A fishing lure as recited in claim 10 wherein the eyelet assembly comprises an elongate shaft, having one end coupled to the elongate body of the lure and an opposing end forming a loop for coupling a fishing line to the elongate shaft.

12. A fishing lure as recited in claim 11 wherein the eyelet assembly comprises a spoon coupled to the elongate shaft, the spoon including a convex surface on one surface of the spoon and a concave surface on an opposite surface of the spoon.

13. A fishing lure as recited in claim 11 wherein the eyelet assembly comprises one or more beads threaded onto the elongate shaft.

14. A fishing lure as recited in claim 10 wherein at least one of the prongs have a sharpened end at a terminal end thereof.

15. A fishing lure, comprising:
a generally rectangular elongate body comprising a semiconductor integrated circuit having a front surface, a back surface, and edge surfaces disposed therebetween, the semiconductor integrated circuit including two generally parallel rows of prongs extending from opposing edge surfaces of the semiconductor integrated circuit;
a hook coupled to a distal end of the elongate body; and
an eyelet assembly coupled to a proximal end of the elongate body, the eyelet assembly comprising an elongate shaft, having one end coupled to the elongate body of the lure and an opposing end forming a loop for coupling a fishing line to the elongate shaft, the eyelet assembly comprising a spoon coupled to the elongate shaft, the spoon including a convex surface on one surface of the spoon and a concave surface on an opposite surface of the spoon.

16. A fishing lure as recited in claim 15 wherein the eyelet assembly comprises one or more beads threaded onto the elongate shaft.

17. A fishing lure as recited in claim 15 wherein at least one of the prongs have a sharpened end at a terminal end thereof.
